(19) United States
(12) Patent Application Publication
(10) Pub. No.: US 2014/0143352 A1
(43) Pub. Date: May 22, 2014

(54) USER PROFILE AND GEOGRAPHY-BASED MEETINGS

(71) Applicant: Sudeep Yegnashankaran, Cupertino, CA (US)

(72) Inventor: Sudeep Yegnashankaran, Cupertino, CA (US)

(73) Assignee: Linkedln Corporation, Mountain View, CA (US)

(21) Appl. No.: 13/682,545

(22) Filed: Nov. 20, 2012

(51) Int. Cl. H04L 12/58

(52) U.S. Cl. CPC H04L 51/32
USPC 709/206

(57) ABSTRACT

A system may include an electronic data storage, a recommendation engine, and a network interface. The electronic data storage may be configured to store a professional skill of a member of a social network. The recommendation engine may be configured to generate a recommendation based, at least in part, on a relationship between the professional skill of the member and a desired professional skill of an organizer and a relationship between a geographic location of the member and a geographic location of the organizer. The network interface may be configured to transmit a meeting invitation to a user device of the member of the social network based, at least in part, on the recommendation.

### TECHNICAL FIELD

The subject matter disclosed herein generally relates to the arrangement of meetings based on social network user profiles and geographic location.

### BACKGROUND

Software applications are known in the art that show a geographic location of various users of the application, such as in relation to one another. Such applications can utilize geographic positioning information from a user device that is operating the application, such as Global Positioning System (GPS) information or triangulation information based on a position of the user device relative to known landmarks, such as cellular transmission towers in the case of mobile phones and other mobile devices. Certain applications alert or otherwise inform a first user as to the proximity of one or more second users of the application. In various such applications, alerts may be offered to the first user without the first user having ever previously met or known a second user.

### BRIEF DESCRIPTION OF THE DRAWINGS

Some embodiments are illustrated by way of example and not limitation in the figures of the accompanying drawings.

FIG. 1 is a block diagram of a system including user devices and a social network system.

FIG. 2 is a block diagram illustrating an example of a social networking system, including a recommendation engine.

FIG. 3 is a block diagram showing some of the functional components or modules that comprise a recommendation engine.

FIG. 4 is a detailed optional example of a social network system.

FIG. 5 is a flowchart for generating and transmitting a meeting invitation to a user device of a member of a social network.

FIG. 6 is a block diagram illustrating components of a machine able to read instructions from a machine-readable medium.

FIG. 7 is an abstract depiction of a user interface screen.

FIG. 8 is an abstract depiction of a user interface screen.

### DETAILED DESCRIPTION

Example methods and systems are directed to user profile and geography-based meetings. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An application has been developed to in essence as act as a beacon to alert a first user of the application as to the geographical proximity of second users of the application based on factors in addition to proximity. Merely alerting a first user of an application as to the physical proximity of second users of the application doesn't account for other factors that may make such an alert or meeting facilitation useful to users of the application. A professional may desire to meet other professionals, such as with particular professional characteristics. Other users may desire to meet users for social reasons. In an example scenario, a professional who desires to meet candidates for a job opening may, at the time of using the application, have little interest in meeting people who do not meet the qualifications for the job opening.

Additionally, the application that has been developed assess proximity based not necessarily on simple proximity but also with respect to travel time needed to effect a physical meeting between the users. A simple notification as to physical proximity between two users of an application may not be useful if one user has only a short period of time in which to meet and travel time for the second user exceeds the period of time that the first user has to meet. The application can factor in an amount of time the first user has to meet, and how long it can be expected to take the second user to transit from the second user's present location to the first user's location.

Overall, the application, in various examples, incorporates various combinations of a geographic proximity, a time transmit to effect a meeting between users of the application, and a relationship between user profiles of users of to issue alerts or otherwise notify the users as to user proximity, such as to arrange an in-person meeting between the users. Such alerts can be transmitted by way of a telephone message, an SMS text message, a video message, and the like. User devices can identify a geographic location of different users. A first user can input desired profile characteristics for a second user and an amount of time the first user will be available for meetings. Based on the available information, the application can alert the first and second users as to potential matches to the information and recommend potential in-person meetings between the users.

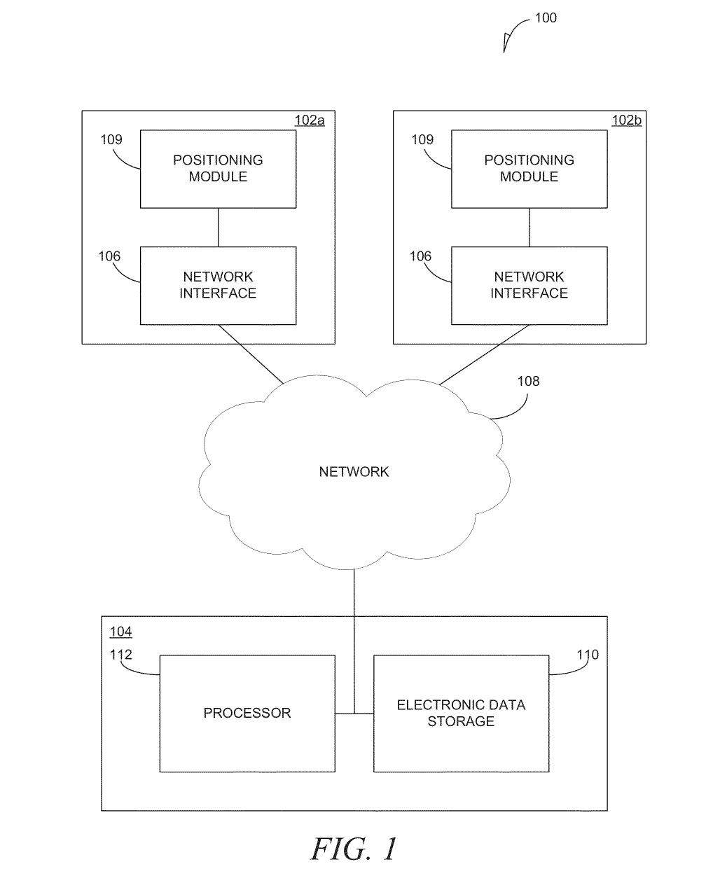

FIG. 1 is a block diagram of a system 100 including user devices 102 and a social network system 104. User devices 102 can be a personal computer, netbook, electronic notebook, smartphone, or any electronic device known in the art that is configured to display web pages. The user devices 102 can include a network interface 106 that is communicatively coupled to a network 108, such as the Internet.

One or more of the user devices 102 can further include a positioning module 109 that can identify a geographic position of the user device 102. In an example, the positioning module 109 incorporates an absolute position function, such as by utilizing the Global Positioning System (GPS) to determine, within a standard margin of error, an absolute geographic location. In an example, the positioning module 109 can utilize triangulation, such as by detecting wireless transmissions from cellular transmitters, 802.11 WiFi transmitters, and Bluetooth transmitters and the like, and identifying a relative position of the user device 102 based on a direction and intensity of the received signals, as well known in the art. In various examples, alternative positioning methods known in the art may be utilized, such as the user of the user device 102 manually reporting a location (for instance, “coffee shop at the intersection of X street and Y avenue in Z city”), by imaging of recognized landmarks, and by cross-referencing ambient sounds detected by a microphone of each of the user devices.

The social network system 104 can be communicatively coupled to the network 108. The system 104 can be an individual server or a cluster of servers, and can be configured to perform activities related to serving the social network, such as storing social network information, processing social network information according to scripts and software applications, transmitting information to present social network information to users of the social network, and receive information from users of the social network. The system 104 can include one or more electronic data storage devices 110, such as a hard drive, and can include a processor 112.

The social network system 104 can store information in the electronic data storage device 110 related to users of the social network, such as in the form of user profiles corresponding to individual users of the social network. For instance, for an individual user, the user's profile can include one or more user characteristics, including, for instance, name, age, gender, profession, prior work history or experience, educational achievement, location, citizenship status, leisure activities, likes and dislikes, professional interests, inventive activities, publications, investments, ventures and so forth. For a company, the information can include name, offered products for sale and details of such products, organizational interests, forthcoming activities, research and development interest, and the like.

In various embodiments, the system 100 includes logic that can identify user profiles that conform to a desired profile. In various examples, upon receiving a request to identify user profiles similar to a particular desired user profile, the system may analyze a variety of user profiles to select one or more user profiles that have the highest aggregate user scores with respect to the desired user profile. The identification can be in real-time, understood to be an analysis that is conducted essentially immediately upon receiving the desired user profile. After identifying the most similar user profiles (e.g., those with the highest aggregate user scores), the system 100 may transmit information related to the desired user to the selected users.

In various examples, the system 100 can generate a list of user profiles with the highest aggregate user scores. The list can be presented to a first user. The first user can identify users who have user profiles that are desirable for meeting and manually select users of the social network to whom a message relating to the company can or should be presented. As noted above, notifications can also be initiated automatically and without the need for manual selection.

In various examples, a recommendation service or feature may generate an average user profile based on the aggregate user profile information of all or some selected users. For instance, the recommendation service may select the average user profile as an input to the user profile matching algorithm, and identify user profiles that are similar to the model desired user profile for the desired user profile. For each user profile that is determined to be similar to the average user profile for a particular desired user profile, the recommendation service may recommend to a user having a user profile similar to the desired user profile for the instant desired user, that the user be presented with the desired user if the user has not already been so presented. In various examples, similarity can be identified on the basis of the user meeting or exceeding characteristics of the average user profile.

The ability to accurately identify in real-time or essentially real-time a set of user profiles most similar to a desired user profile (or, in various examples, a set of desired user profiles most similar to a user profile) can be achieved with a general recommendation engine. Accordingly, at least in some examples, the recommendation engine provides a recommendation service that can be customized for use with multiple applications or services. A recommendation entity can be a collection of information organized around a particular concept that is supported by the system 100 in general, and the recommendation engine in particular. For instance, some examples of recommendation entities are: user profiles, interest groups, companies, advertisements, events, news, discussions, tweets, questions and answers, ventures, projects, skills, and so forth. Accordingly, in some examples, by specifying the particular characteristics of two recommendation entities to be compared, and by specifying a particular algorithm for use in generating an aggregate score, such as in this instant example an aggregate user score, for the two recommendation entities, the recommendation engine can be configured and customized to perform such tasks as: generate aggregate user scores for use in recommending desired user listings to a user, generate aggregate user scores for use in recommending particular interest groups that a user might be interested in joining; generate aggregate user scores for use in recommending particular jobs the user might be interested in applying for, generate aggregate user scores for people the user may be interested in meeting; generate aggregate user scores for use in displaying an appropriate or relevant advertisement to a particular user, and many others.

In an example, the recommendation engine operates in two phases. In the first phase, the data representing each individual instance of a particular recommendation entity, such as the user profile and the desired user profile, is processed by a characteristic extraction engine to extract the relevant characteristics on which matching analysis is to be performed. In various examples, in the case of a user profile, only certain characteristics or portions of a user's profile may be selected for use in determining the similarity of any two profiles, such as the user profile and a desired user profile. As such, during the first phase, a characteristic extraction engine processes each user profile to extract the relevant profile characteristics from each user profile. In addition to simply extracting certain characteristics from relevant recommendation entities, the characteristic extraction engine may derive certain characteristics based on other information included in the recommendation entity, such as from the user profile.

In an example, characteristics that may be used to identify similarities between a user profile and a desired user profile is job title, interests, and consumer goods that the user likes. In addition, in some examples, the characteristic extraction engine may standardize and/or normalize various characteristics, such as a user's company or position title, or the name of a company at which a user has indicated being employed. In some examples, certain profile characteristics may be retrieved from external data sources, using other information included in the recommendation entity as part of a query to the external data source.

The first phase may occur in real-time or as a background operation, such as offline or as part of a batch process. In some examples that incorporate relatively large amounts of data to be processed, the first phase may be achieved via a parallel or distributed computing platform. Once the relevant characteristics have been extracted, computed, derived, or retrieved, relevant characteristics of the users or companies can be stored as a pre-processed recommendation entity. For instance, in the case of a user profile, the characteristic extraction process can result in an enhanced user profile that includes only the relevant characteristics extracted from a user's profile as well as any derived or retrieved profile characteristics. The enhanced profile can be used during the recommendation engine's second phase, when the matching engine compares the relevant profile characteristics from the desired user profile against each user profile until those user profiles with the highest aggregate user scores are identified. The matching engine can utilize equality matching, complementary matching (e.g., skills that are different but that may useful as matched pairs), and supplementary matching (e.g., skills where one skill reflects a specialized subcategory of another skill).

In an example, during the second phase, the matching engine of the recommendation engine uses a configuration file that is customized for the particular analysis being performed. For example, a first configuration file (referred to herein as a profile matching configuration file) may exist for use in identifying user profiles similar to a desired user profile, whereas a second configuration file—specifying different characteristics from different recommendation entities to be compared, and a different algorithm for computing the matching scores—may be specified for determining the desired user characteristics that are most likely to be of interest to a particular user. As such, by configuring the characteristic extraction engine to extract relevant data from certain recommendation entities, and customizing the analysis performed by the matching engine with an appropriate configuration file, a wide variety of recommendation operations can be achieved with the general recommendation engine. In addition, the extraction engine can include filters, such as to provide screening of users who have particular undesired characteristics.

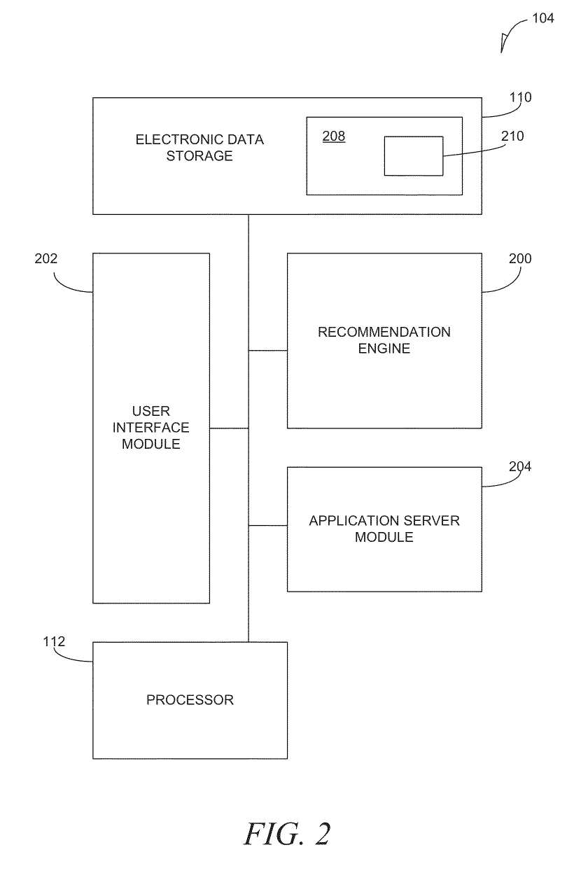

FIG. 2 is a block diagram illustrating an example of the social networking system 104, including a recommendation engine 200 for identifying similarities between different recommendation entity types, such as member profiles and desired member profiles. In an example, the social networking system 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking system 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network system 104 consists of a user interface module 202 (such as a user interface portal to the social network system 104 or a separate web server that functions as a component of the wider server functionality of the social network system 104), which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 200, generates various user interfaces (e.g., web pages) with data retrieved from various data sources in the data layer. With some embodiments, individual application server modules 204 are used to implement the functionality associated with various services and features of the system 100. For instance, the ability to identify member profiles similar to a desired member may be a service implemented in an independent application server module 204. Similarly, other applications or services that utilize the recommendation engine 200 may be embodied in their own application server modules 204.

The data layer can include several databases, such as a database 208 for storing recommendation data, such as member profiles and desired member profiles, and can further include additional social network information, such as interest groups, companies, advertisements, events, news, discussions, tweets, questions and answers, and so forth. In some examples, the recommendation entity data is processed in the background (e.g., offline) to generated pre-processed entity data, that can be used by the recommendation engine, in real-time, to make recommendations generally, and to identify member profiles similar to a desired member profile. In an example, the recommendation engine 200 may retrieve and process member profile data 210 in the database 208 to identify member profiles similar to a desired member profile. The database 208 can store application configuration data, including one or more configuration files for use with the recommendation engine 200.

In various examples, when a person initially registers to become a member of the system 100, the person can be prompted to provide some personal characteristics, such as his or her name, age (such as by birth date), gender, interests, contact information, home town, address, the names of the member's spouse and/or family members, educational background (such as schools, majors, etc.), employment history, skills, professional organizations, and so on. This information can be stored, for example, in the database 208.

Once registered, a member may invite other members, or be invited by other members, to connect via the system 100. A “connection” may involve a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, in some examples, does not require acknowledgement or approval by the member that is being followed. When one member follows another, the member who is following may receive automatic notifications about various activities undertaken by the member being followed.

The system 100 may provide a broad range of other applications and services that allow member the opportunity to share and receive information, often customized to the interests of the member. In some examples, the system 100 may include a photo sharing application that allows members to upload and share photos with other members. In some examples, members may be able to self-organize into groups, or interest groups, organized around a subject matter or topic of interest. With some embodiments, members may subscribe to or join groups affiliated with one or more companies. For instance, with some embodiments, members of the system 100 may indicate an affiliation with a company at which they are employed. With many of these applications and services, one or more recommendation entities may be involved. For instance, in addition to identifying member profiles that are similar to a desired member profile, the recommendation engine 200 may be configured and customized to identify groups, companies or photos that are likely to be of interest to a particular member.

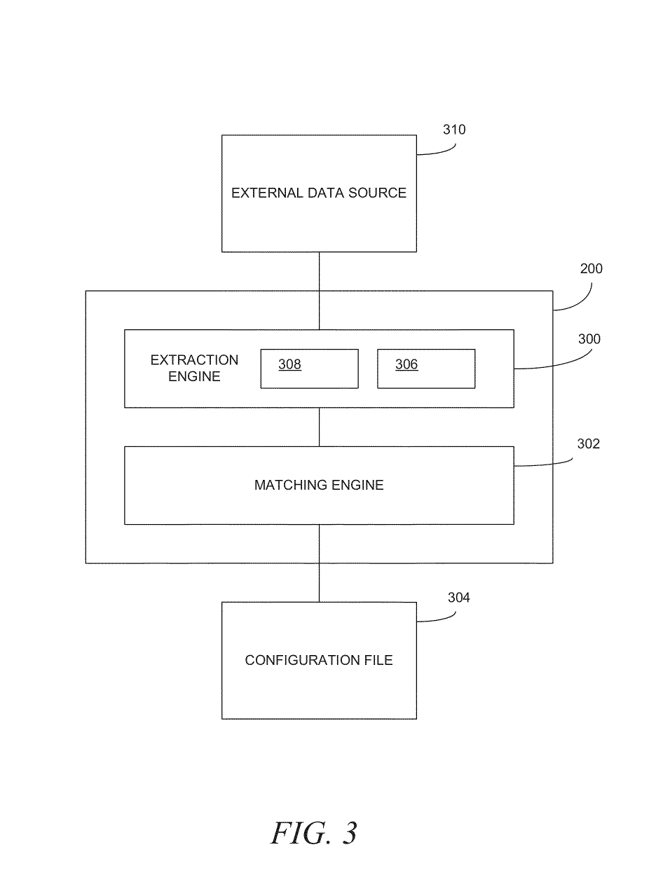

FIG. 3 is a block diagram showing some of the functional components or modules that comprise a recommendation engine 200, in some examples, and illustrates the flow of data that occurs when performing various operations of a method for identifying and presenting member profiles that are similar to a desired member profile. As illustrated, the recommendation engine 200 consists of two primary functional modules—a characteristic extraction engine 300 and a matching engine 302. The characteristic extraction engine 302 can be customized to extract various characteristics from various recommendation entities, and then operating the matching engine 302 under the direction of a particular configuration file 304 to perform a particular type of matching operation that is specific to the requesting application. In various examples, inputs and outputs can be metered or otherwise impacted by fees paid by various entities, such as fees for a number of results returned, the matching processes used, and so forth. Depending upon the particular inputs to the recommendation engine 200 and the desired outputs, different configuration files 304 may be used to compare different characteristics of different recommendation entities. For instance, to identify member profiles that are similar to a desired member profile, a particular configuration file 304 (referred to herein as a profile matching configuration file) may be used, while different configuration files 304 may be used to perform other tasks.

In the case of identifying member profiles similar to a desired member profile, the profile matching configuration file 304 is used as an input to the matching engine 302 to specify the various member profile professional skills that the matching engine is to extract from the pre-processed member profile data 210 and to compare. In addition, the profile matching configuration file 304 can specify an algorithm for comparing profile characteristics and generating an overall matching score.

In various examples, each member's and desired member's profile data 210 is provided as input to the characteristic extraction engine 300, processed by the characteristic extraction engine 300, and then output and stored as pre-processed member profile data 210. In some examples, the characteristic extraction engine 300 may extract only relevant characteristics from whatever recommendation entity is being processed by the characteristic extraction engine. So, for example, in the case of a member profile, the characteristic extraction engine 300 may extract only the profile characteristics that are necessary for making the determination of whether a member profile is similar to a desired member profile. However, in some examples, all characteristics are extracted, while only certain characteristics are further processed or refined.

As illustrated, the characteristic extraction engine 300 includes a characteristic derivation module 306 and a data retrieval module 308. In some examples, the characteristic derivation module 306 derives certain characteristics (e.g., profile characteristics) based on the data input to the characteristic extraction engine. For instance, in the case of member profiles, the characteristic derivation module 306 may derive one or more profile characteristics from the information included in a member's profile. Similarly, the data retrieval module 308 may utilize information input to the characteristic extraction engine 300 to formulate a query that is communicated to an external data source 310. As such, the data retrieval module 308 of the characteristic extraction engine 300 can retrieve various profile characteristics from one or more external data sources, such that these retrieved profile characteristics can be used to determine the similarity of any two member profiles.

In addition to deriving various profile characteristics, and retrieving various profile characteristics, the characteristic extraction engine 300 can include logic to normalize or standardize certain profile characteristics. For instance, in some examples, a member may be prompted to provide his or her job title. Because job titles can vary from one desired member to the next, and from one industry to the next, job titles may be normalized or standardized. For example, the simple job title “analyst” may have very different meanings in different industries or even between different departments within the same company or organization. By normalizing and/or standardizing the job titles and then writing the standardized and normalized job titles to each member's enhanced profile, the ability of the recommendation engine to make effective comparisons may be enhanced, and thereby provide relatively accurate results when presenting member profiles similar to a desired member profile.

After the characteristic extraction engine 300 has generated the pre-processed member profile data 210, the matching engine 302 is able to process client requests to identify member profiles similar to a desired member profile. In some examples, the client of the matching engine 302 may simply be a server-side application that is requesting the information from the matching engine 302. Accordingly, the requesting application may specify or determine the particular configuration file that is to be used by the matching engine 302 to perform the requested task and achieve the requested objective. When a request is received at the matching engine 302 to provide a list of member profiles similar to a desired member profile, the matching engine 302 can use the profile matching configuration file 304 to determine the particular member profile characteristics that are to be retrieved from the various enhanced member profiles. In addition, in various examples, the profile matching configuration file 304 can specify the exact comparisons that are to be performed, and how the overall matching score is to be calculated. Accordingly, the particular profile matching configuration file 304 can include instructions or directives for use by the matching engine 302 to perform the necessary profile characteristic comparisons, and to generate the aggregate desired member scores for each member profile, such that the aggregate member score for each member profile indicates the similarity of the member profile with respect to the desired member profile.

In some examples, the matching engine 302 can compare multiple individual profile characteristics such that each compared profile characteristic results in an aggregate member score (referred to herein as a sub-score, to reflect that the sub-score is a component of the overall aggregate member score). Once each sub-score is determined, the sub-scores are combined in some manner indicated by the profile matching configuration file 304. That is, the profile matching configuration file 304 will dictate how the matching engine 302 is to weight and combine the individual similarity sub-scores to derive the overall aggregate member score for each member profile.

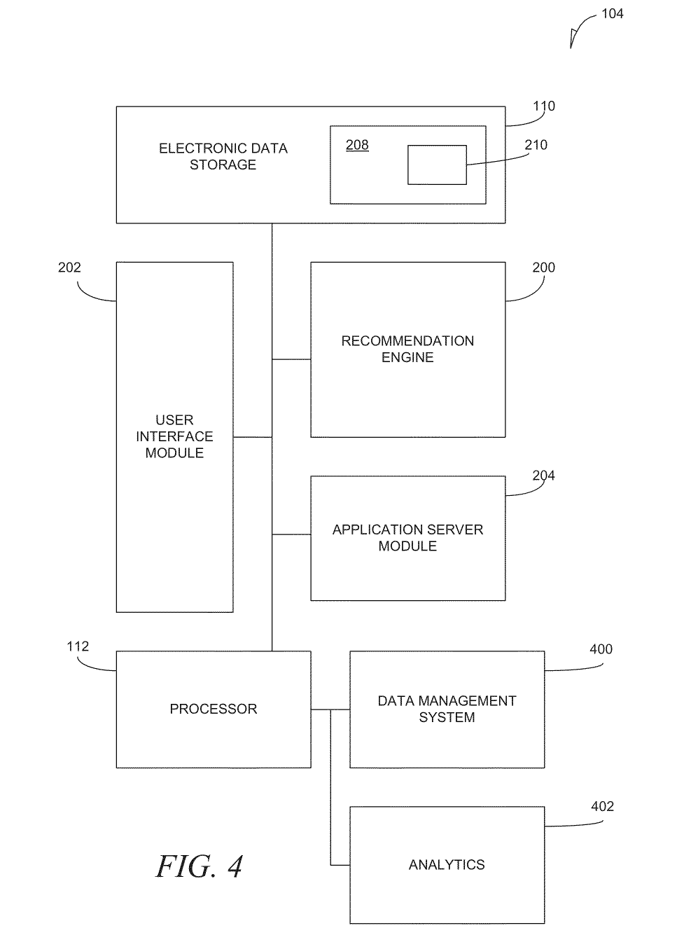

FIG. 4 is a detailed optional example of the social network system 104. The social network system 104 includes a recommendation engine 200. The recommendation engine can incorporate the recommendation engine 200 or can be an adapted form of the recommendation engine 200.

The system 104 can include a user interface 202, such as with a user interface coupled to the system 104 or via the network interface 106. The user interface 202 is coupled to a data management system 400. The data management system 400 can incorporate data management technologies well known in the art or can incorporate proprietary data management structures. In an example, the data management system 400 incorporates SAS or Statistical Analysis System data management systems, to promote business analysis, statistical analysis, data storage and recover, and the like for company information. The data management system 400 can include the capacity for social network administrators to utilize the data generated by the data management system 400, such as by inputting tasks into the data management system.

The user interface 202 and the data management system 400 can be coupled to the database 208. The user interface 202 can transmit member data, such as member profiles, to the database 208 for storage without respect to data management activities. The data management system 400 can store member data in the database 208 upon the company data having been acted upon for data management analysis.

The network interface 106 can provide the input of member data, such as a member profile, into the social network. The member profile can be stored in the database 208 or can be directly transmitted to the recommendation engine 200 for cross reference against the member profiles stored in the database 208. Members identified by the recommendation engine 200 can be transmitted via the network interface 106 to the user device 102 for presentation to the user.

A user analytics system 402 can track the occurrence of alerts or notifications that have been presented to or selected by a member. A member message that effects a meeting between two members that is regarded by the members as appropriate can be regarded as a successful message. A member message that does not effect an appropriate meeting between members can be regarded as unsuccessful. The application can be adjusted and tested based on such analytical information.

In various examples, the database 208 incorporates multiple member profiles. The recommendation engine 200 is configured to determine an aggregate member score for at least some of the member profiles in the database 208 by incorporating a relevance of the desired member profiles to a member profile using the recommendation engine 200.

In various examples, when a member accesses the application, the recommendation engine 200 cross references the member's profile against some or all of the desired member profiles in the database 208. The recommendation engine 200 can generate a relevance for each of the cross referenced profiles. The recommendation engine 200 can utilize a processor 112 (in various examples, the processor 112 is the processor 112 of the system 100) can manipulate the relevance for the member profile by a corresponding company bid.

### Operation

In various examples, a member of a social network desires to be an organizer for in-person meetings with other members of the social network. The organizer can utilize a positioning module 109 of a user device 102a of the member to obtain a geographic location of the user device 102a. The geographic location of the user device 102a can be transmitted via the network interface 106 and the network 108 to the social network system 104. In various examples, the organizer can further utilize the user device 102a to specify desired professional skills of other members of the social network that the organizer would like to have in a person with which the organizer effects an in-person meeting.

In an example, a software application, such as a software application related to the social network, presents an interface on the user device 102a. The interface can allow the organizer to specify a profile of particular desired professional skills, such as a professional field, a current job, a professional degree, and an amount of experience in at least one of a professional field and a job, and so forth as disclosed herein and as would be apparent. In various examples, the software application can present a standard list of desired user professional skills, can allow a user to create a custom profile of desired user professional skills, or can include preselected and custom professional skills, such as those skills the system 100 identifies as relevant and/or applicable to the user. In various examples, the organizer can input a job posting and the application can derive desired professional skills from the requirements of the job posting.

In various examples, the application can allow a user to input a desired member profile from predetermined sources. Such predetermined sources can include the profile of the organizer or the profile of another member of the social network. The predetermined sources can be based on a cross-section of individuals, such as members of a social network group. In such cross-sectional desired users, a group can upload desired professional skills or other characteristics for individuals who are similar to the average professional skills of the group; for instance, if a group primarily comprised of young professional engineers desires to expand the group with similar individuals, the group may input the average professional skills of the group as the desired professional skills. In such examples, numerical characteristics, such as age and work experience, may be actually averaged, while alternative statistics measures, such as most common professional skill, may be applied to non-numeric professional skills, such as professional field. In various examples, a group can seek complementary professional skills; for instance, a group that wants to diversity its membership may seek desired professional skills that are contrary to the group's average professional skills. The application can calculate and coordinate such group average professional skills.

In various examples, an organizer can additionally specify a duration of time the organizer will or expects to be available for in-person meetings. In an example, a organizer can specify that the organizer will be in their general location for various lengths of time, ranging from minutes to days or more. In various examples, the organizer may specify any length of time the organizer expects to be in a particular location. The organizer may further specify, for instance, a start date and time for prospective meeting times.

Upon uploading the geographic location of the user device 102a, the desired professional skills, and, in various examples, the time the organizer is available into the social network system 104, the processor 112 can utilize the recommendation engine 200 to compare the desired professional skills against one or more of the members of the social network who both adequately meet the desired professional skills according to the criteria of the recommendation engine 200 and who are in geographic proximity of the user device 102a.

In various examples where the organizer included an available time for meeting, the processor 112 can utilize the time for meeting to determine whether to recommend a member associated with a second user device 102b for an in-person meeting. In various examples, the processor 112 does not take such considerations into account, and instead leaves it to the second user device 102b or the member associated with the second user device 102b to determine whether a meeting would be feasible given the time constraints.

In an example, the social network application can determine an estimated time to transit from the current location of the second user device 102b to the first user device 102a. In an example, the second user device 102b calculates an estimated time to transit from the location of the second user device 102b to the location of the first user device 102a using a third party application known in the art. In various examples, the time to transit from the location of the second user device 102b to the location of the first user device 102a can be determined according to various methods known in the art, including by automobile, by walking, by bicycling, by public transit, and/or by other modes of transit known in the art.

In various examples, the member can indicate on the second user device 102b the member's current available time for meetings and available transportation. If the organizer only has thirty minutes for an in-person meeting while the member is approximately thirty minutes away from the organizer given the second user's available or preferred mode of transportation, the social network application may not notify the member of the possible in-person meeting.

In an example, prior to alerting the second user, the system 100 as a whole presents at least some of the matches made by the recommendation engine 200 to the user on the user device 102a. In such an example, the organizer can utilize the user device 102a to select which one or more of the recommended members will be alerted as to the location of the organizer. In various examples, the members are simply alerted directly via their respective user devices 102 without prior notification or the option of selection given to the organizer.

In an example, the second user device 102b alerts the member of the option of an in-person meeting with the organizer by pushing a notification to the member, such as by audio (e.g., a tone or verbal message) or mechanical notification (e.g., vibration) of the second user device 102b, whether or not the member is using the social network application. In an example, the second user device 102b provides a passive notification, displaying a message concerning the possible meeting with the organizer only when the member selects the social network application or otherwise engages in an affirmative desire to be notified. In various examples, the member may select between passive and active notification.

In various circumstances, when the organizer indicates an availability for in-person meetings the member may be prompted to accept the offer of an in-person meeting or may simply proceed to location of the first user device 102a. In circumstances where many members may be in sufficient proximity of the organizer device 102a, it may be undesirable to potentially flood the organizer with in-person meetings. As such, the processor 112 may limit alerts to organizer according to the member's matching of the desired professional skills, according to the member's proximity to the organizer, and/or according to various criteria. In an example, a member who has a match with the desired professional skills of eighty-five (85) percent may be notified ahead of a member with a match of the desired criteria of seventy (70) percent. The processor may alert a predetermined number of the closest matches with the desired professional skills.

The desired professional skills may be weighted to favor relatively geographically close members, such that a relatively worse match may be given higher priority if the member corresponding to the worse match is in closer or significantly closer geographic proximity of the organizer. Thus, a member with a seventy (70) percent match who is a five (5) minute walk from the organizer may be given priority ahead a member with an eighty-five (85) percent match who is a thirty (30) minute drive away from the organizer. In various examples, a member must meet a minimum professional skill match threshold to be alerted. In various examples, the threshold is organizer selectable or is predetermined by the social network. In an example, the threshold is seventy-five (75) percent.

The results of the recommendation engine 200 can be weighted according to various additional factors. For instance, in circumstances where multiple organizers are offering in-person meetings in close proximity of one another, such as at a “networking” event, a member may receive multiple alerts for in-person meetings. The social network may prioritize the alerts according to weighting factors, such as a size of a monetary bid by various organizers or according to criteria from the networking event, such as precedence of one organizer over another within the networking event, a charitable donation, and so forth. Members who may make prospective matches may similarly bid or otherwise weight recommendations.

In circumstances with additional weighting factors, a size of a bid or other comparable factor may be multiplied or otherwise used to manipulate the result of the recommendation engine 200. For example, a monetary bid of one (1) dollar may increase a percentage result of the recommendation engine 200 by a predetermined amount, such as by ten (10) percent. Thus, a recommendation engine 200 result of fifty (50) percent may be treated as if it were a percentage result of sixty (60) percent if the organizer or member has bid one (1) dollar.

The social network application may further function as a scheduling application, prompting members with a particular time in which the organizer may be available for an in-person meeting. In various examples, the processor 112 can determine when a member is likely to arrive for an in-person meeting and time alerts to matching members accordingly. Alternatively, the member can be presented with a schedule and select a time to meet with the organizer. Scheduled meeting durations can be selectable by the meeting organizer or can be ad hoc. In various examples, the organizer or a matching member can note that an in-person meeting has started or completed and the social network can transmit alerts to other matching members based on the availability of the organizer at any given time.

In various examples, the organizer indicates availability for in-person meetings in real-time. In an example, the organizer is in a publicly accessible place, such as a coffee shop, restaurant, or public building, and utilizes the first user device 102a to input desired professional characteristics and, potentially, an available time for meetings. The social network system 104 then identifies matches among social network members and transmit alerts in one or more of the various forms disclosed herein, whereupon the matched members may proceed to an in-person meeting with the waiting organizer.

In various examples, the in-person meetings can be arranged for private locations, such as a home or office. In such examples, the organizer can limit transmittal of alerts to matching members who meet various criteria, such as that the matching members have a previous connection to the organizer within the social network or have previous access to the private location, such as if the matching member is an employee of a company at which the organizer is located. As noted above, matching members can additionally be presented to the organizer for approval prior to alerts being sent to the matching member.

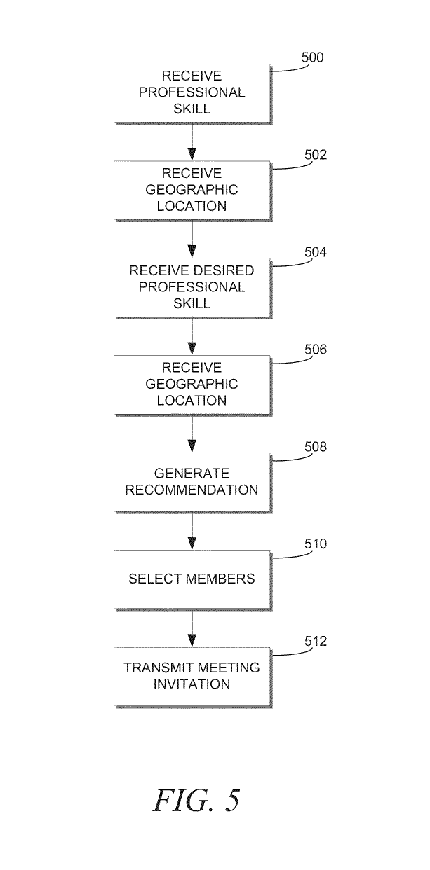

FIG. 5 is a flowchart for generating and transmitting a meeting invitation to a user device of a member of a social network. While the flowchart will be described with respect to system 100 in particular, the flowchart is applicable to any suitable system or hardware.

At 500, the system 100 generally, and, in an example, the recommendation engine 200 specifically, receives a professional skill of a member of the social network. The professional skill can be a component of a social network profile of the member for the social network provided by the social network server 104. The professional skill, and the user's social network profile generally, can be or include any one or more of a professional field, a current job, a professional degree, an amount of experience in at least one of a professional field and a job, past job titles, professional connections, professional endorsements, and professional recommendations. In various examples, a professional skill for multiple members of the social network is received.

At 502, the social network server 104 generally and, in an example, the recommendation engine 200 specifically, can receive a geographic location of a user device 102b of the member of the social network. The geographic location can be generated by the positioning module 109 of the user device 102b and transmitted to the server 104 via the network 108.

At 504, a desired professional skill desired by a meeting organizer is received by the social network server 104, generally, and, in an example, the recommendation engine 200, specifically. The desired professional skill can be a part of a desired skill profile and can be input into the user device 102a by the organizer. The professional skill, and the social network profile generally, can be or include any one or more of a professional field, a current job, a professional degree, an amount of experience in at least one of a professional field and a job, past job title, professional connections, and professional recommendations.

At 506, the social network server 104 generally and, in an example, the recommendation engine 200 specifically, can receive a geographic location of a user device 102a of the organizer of the meeting. The geographic location can be generated by the positioning module 109 of the user device 102a and transmitted to the server 104 via the network 108.

At 508, the recommendation engine 200 generates a recommendation based on a relationship between the professional skill of the member and the desired professional skill of the organizer and a relationship between the geographic location of the user device 102b of the member and the geographic location of the user device 102a of the organizer. The relationship between the geographic locations can be based, at least in part, on a distance between the geographic location of the member and the geographic location of the organizer, and, in various examples, can be based on an estimated time to transit from the geographic location of the member to the geographic location of the organizer. In an example, the time to transit from the geographic location of the member to the geographic location of the organizer based on one of a plurality of transit modes. In such an example, the transit modes are at least one of walking, driving, public transit, bicycle, and other modes of transport known in the art. In an example, the recommendation engine 200 generates the recommendation based, at least in part, on an estimated available time of the organizer. In such an example, the organizer can input an available time on the user device 102a.

In various examples where multiple members are evaluated by the recommendation engine 200, the recommendation engine 200 can develop a separate recommendation score for each member. In an example, the recommendation engine 200 can rank the recommendation scores of each of the members who were evaluated. The recommendation engine 200 can recommend individual members of the social network for a meeting based on a predetermined number of the highest recommendation scores. In such an example, the predetermined number can be preset by the social network server 104 or can be selectable by the organizer on the user device 102a.

At 510, the social network server 104 optionally presents the recommendation to the organizer, such as on the user device 102a. The organizer can optionally select ones of the recommendations corresponding to particular desired members of the social network.

At 512, the social network server 104 transmits a meeting invitation to the user device 102b of the member as recommended by the recommendation engine 200. The meeting invitation can be displayed on the user device 102b of the member. In embodiments in which the organizer optionally selects members who receive the meeting invitation, as in 510, the meeting invitation is transmitted only to user device 102b of members who are selected by the organizer.

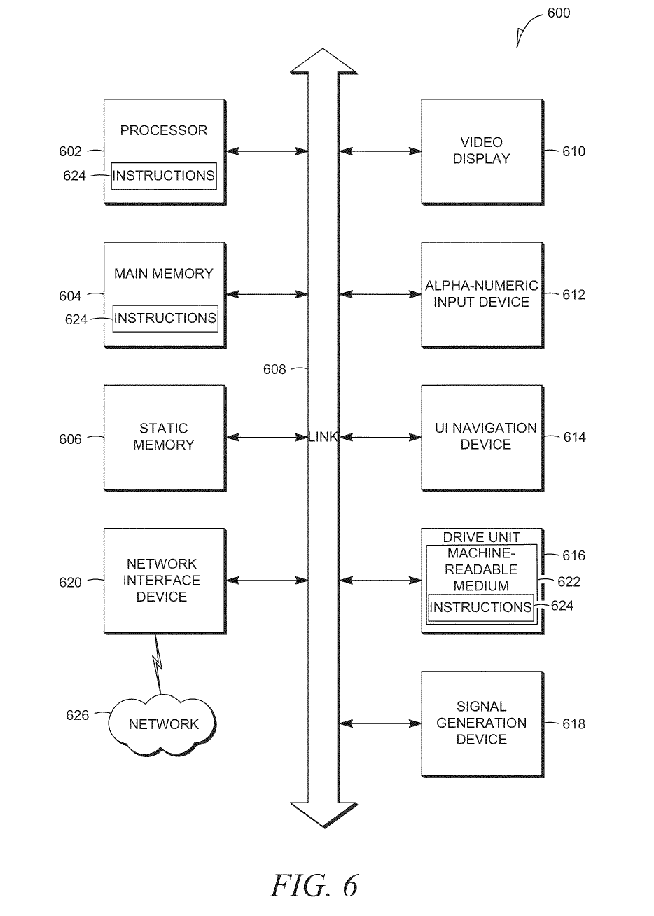

FIG. 6 is a block diagram illustrating components of a machine 600, according to some examples, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative examples, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

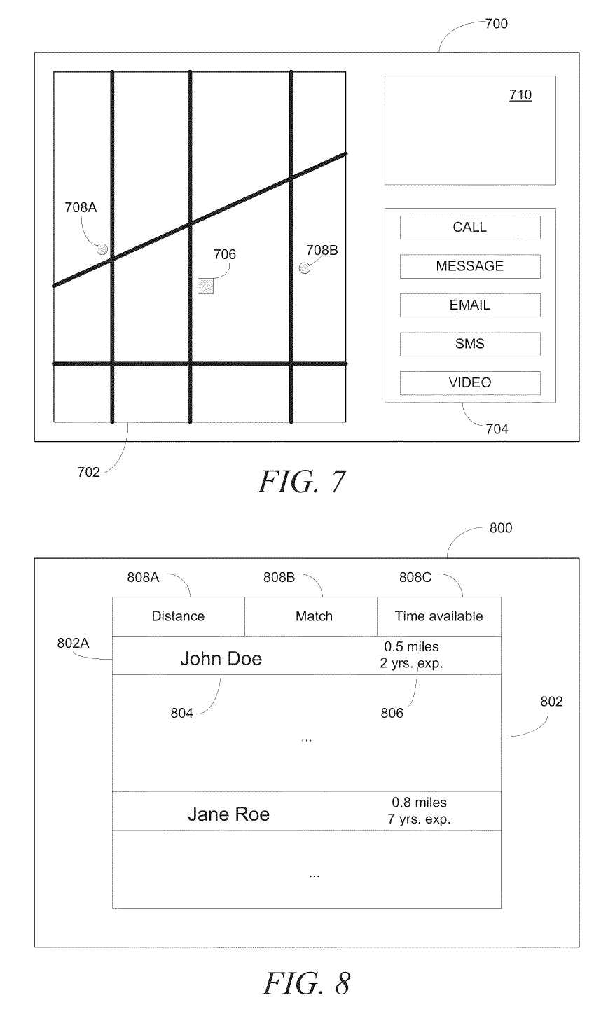

FIG. 7 is an abstract depiction of a user interface screen 700, such as can be displayed on the user device 102 of the organizer. The user interface screen 700 includes a selectable map 702 and an options menu 704. In various examples, the map 702 is a webpage, a program that has a map screen, or a map program that is a native application on the organizer's user device 102, or is a proprietary map related to the social network. In various examples, the map 702 can display an icon 706 denoting a current location of the organizer and icons 708A, 708B denoting a current location of members who have been identified by the recommendation engine 200 as meeting the criteria established by the organizer.

In various examples, the organizer can select a member by selecting the icon 708A of the member on the map 702. Upon selection of the icon 708A on the map 702, an information window 710 may display information relating to the member. As illustrated, the information window 710 is not part of the map 702 window, but in various embodiments the information window 710 is incorporated into the map 702 window, such as by popping up next to an icon 708 upon the icon 708 being selected. The organizer may then utilize the option menu 704 to choose whether or not to request a meeting and to specify the modality by which the message is transmitted. In the illustrated example, the decision select whether to transmit a meeting request is implicit in the selection of the modality by which the meeting request is transmitted, i.e., the simple selection of “SMS” implicitly selects that the meeting will occur along with the mode by which the meeting request is transmitted.

FIG. 8 is an abstract depiction of a user interface screen 800, such as can be displayed on the user device 102 of the organizer. The screen 800 includes a selectable list 802 of potential matches as identified by the recommendation engine 200. The entries include a name 804 of the various identified members and, in various examples, fields 806 for a brief information summary, in the illustrated example a distance to the organizer and a number of years of relevant experience. Additional information that can be displayed includes an amount of time available to meet, common profile characteristics between the member and organizer, and so forth. It is noted that, in various specific implementations of the screen 800, various information in the name 804 and information 806 fields can be dispensed with, added to, or anonymized. In various examples, individual members can incorporate privacy rules that may make information protected from distribution to various organizers and/or anonymized.

The screen 800 further includes tabs 808 by which the results on the list 802 can be organized. As illustrated, the distance tab 808A has been selected and the list 802 is displayed according to which members are physically closest to the organizer. The match 808B and time available tabs 808C may be selected to organize the list 802 according to a degree to which the recommendation engine 200 has identified the members match the criteria and according to an amount of time available to meet, respectively. Additional tabs 808 can be included or utilized to replace the illustrated tabs.

In various examples, selecting a particular entry on the list 802A can display more detailed information regarding the selected member. Upon selecting a particular member 802A, the organizer may be prompted whether to transmit a meeting invitation, such as with an options menu 704 from the screen 700. In various alternative examples, selecting a particular member 802A automatically transmits a meeting invitation. The list-based screen 800 can be utilized in place of or in conjunction with the map-based screen 700.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A memory device, the memory device communicatively coupled to a processor and comprising instructions which, when performed on the processor, cause the processor to:
receive a professional skill of a member of a social network;
receive a geographic location of a user device of the member of the social network;
receive a desired professional skill of an organizer;
receive a geographic location of a user device of the organizer;
generate a recommendation based, at least in part, on:
a relationship between the professional skill of the member and the desired professional skill of the organizer; and
a relationship between the geographic location of the user device of the member and the geographic location of the user device of the organizer; and
transmit a meeting invitation to the user device of the member of the social network based, at least in part, on the recommendation.

2. The memory device of claim 1, wherein the memory device further comprises instructions that further cause the processor to determine the relationship between the geographic location of the member and the geographic location of the organizer based, at least in part, on a distance between the geographic location of the member and the geographic location of the organizer.

3. The memory device of claim 2, wherein the memory device further comprises instructions that further cause the processor to determine the distance based, at least in part, on an estimated time to transit from the geographic location of the member to the geographic location of the organizer.

4. The memory device of claim 3, wherein the time to transit from the geographic location of the member to the geographic location of the organizer based on one of a plurality of transit modes.

5. The memory device of claim 1, wherein the desired professional skill of the organizer and the professional skill of the member are at least one of a professional field, a current job, a professional degree, an amount of experience in at least one of a professional field and a job, a past job title, professional connections, and professional recommendations.

6. The memory device of claim 5 wherein the memory device further comprises instructions that further cause the processor to generate the recommendation based on a desired profile of the organizer and a profile of the member comprising a plurality of professional skills.

7. The memory device of claim 1, wherein the memory device further comprises instructions that further cause the processor to present the recommendation to the organizer on a user device of the organizer, wherein the meeting invitation is transmitted based on an organizer selection of the recommendation.

8. The memory device of claim 1, wherein the memory device further comprises instructions that further cause the processor to generate the recommendation further based on an available time of the organizer.

9. The memory device of claim 1, wherein the memory device further comprises instructions that further cause the processor to:
receive a professional skill and a geographic location from each of a plurality of members of the social network;
generate a recommendation for each of the plurality of members of the social network; and
transmit the meeting invitation to individual user devices associated with individual ones of the members based on the recommendation for each of the plurality of members.

10. The memory device of claim 9, wherein the memory device further comprises instructions that further cause the processor to:
generate a rank of a recommendation score for each of the plurality of members with respect to the recommendation scores for each of the plurality of members; and
transmit the meeting invitation to individual user devices based on a rank of the recommendation for each of the plurality of members.

11. The memory device of claim 10, wherein the memory device further comprises instructions that further cause the processor to transmit the meeting invitation to individual user devices corresponding to ones of the plurality of members having a highest rank.

12. A system comprising:
an electronic data storage configured to store a professional skill of a member of a social network;
a recommendation engine configured to generate a recommendation based, at least in part, on:
a relationship between the professional skill of the member and a desired professional skill of an organizer; and
a relationship between a geographic location of the member and a geographic location of the organizer; and
a network interface configured to transmit a meeting invitation to a user device of the member of the social network based, at least in part, on the recommendation.

13. The system of claim 12, wherein the recommendation engine is further configured to determine the relationship between the geographic location of the member and the geographic location of the organizer based, at least in part, on a distance between the geographic location of the member and the geographic location of the organizer.

14. The system of claim 13, wherein the recommendation engine comprises a processor configured to determine the distance based, at least in part, on an estimated time to transit from the geographic location of the member to the geographic location of the organizer.

15. The system of claim 14, wherein the time to transit from the geographic location of the member to the geographic location of the organizer based on one of a plurality of transit modes.

16. The system of claim 12, wherein the desired professional skill of the organizer and the professional skill of the member are at least one of a professional field, a current job, a professional degree, an amount of experience in at least one of a professional field and a job, a past job title, professional connections, and professional recommendations.

17. The system of claim 16 wherein the recommendation engine is configured to generate the recommendation based on a desired profile of the organizer and a profile of the member comprising a plurality of professional skills.

18. The system of claim 12, wherein the network interface is configured to transmit the recommendation to the organizer on a user device of the organizer, wherein the meeting invitation is transmitted based on an organizer selection of the recommendation.

19. The system of claim 12, wherein recommendation engine is configured to generate the recommendation further based on an available time of the organizer.

20. The system of claim 12, wherein the recommendation engine is configured to generate a recommendation for each of a plurality of members of the social network based, at least in part, on a professional skill and a geographic location from each of a plurality of members of the social network; and
wherein the network interface is configured to transmit the meeting invitation to individual user devices associated with individual ones of the members based on the recommendation for each of the plurality of members.

21. The system of claim 20, wherein the recommendation engine is configured to generate a rank of a recommendation score for each of the plurality of members with respect to the recommendation scores for each of the plurality of members; and
wherein the network interface is configured to transmit the meeting invitation to individual user devices based on a rank of the recommendation for each of the plurality of members.

22. The system of claim 21, wherein the network interface is configured to transmit the meeting invitation to individual user devices corresponding to ones of the plurality of members having a highest rank.
